(19) United States
(12) Patent Application Publication
(10) Pub. No.: US 2022/0243027 A1
(43) Pub. Date: Aug. 4, 2022

(54) Extraction Materials for In-Situ Consolidation and Multi-Packaging of Underwater Fragile Cultural Relics, and Extraction and Restoration Methods

(71) Applicant: Zhejiang University, Hangzhou (CN)

(72) Inventors: Bingjian Zhang, Hangzhou (CN); Xueqiang Chen, Hangzhou (CN); Xinxin Wang, Hangzhou (CN)

(21) Appl. No.: 17/588,290

(22) Filed: Jan. 30, 2022

Related U.S. Application Data
(63) Continuation-in-part of application No. PCT/CN2021/101103, filed on Jun. 19, 2021.

(30) Foreign Application Priority Data
Feb. 4, 2021 (CN) 202110157108.1

(51) Int. Cl. C08J 9/40; C08J 9/36; C08J 9/00; B01J 20/28; B01J 20/26

(52) U.S. Cl. CPC C08J 9/40; C08J 9/365; C08J 9/0066; C08J 2463/02; B01J 20/262; C08J 2375/04; B01J 20/28045

(57) ABSTRACT

The present disclosure discloses extraction materials for in-situ consolidation and multi-packaging of underwater fragile cultural relics, and extraction and restoration methods.

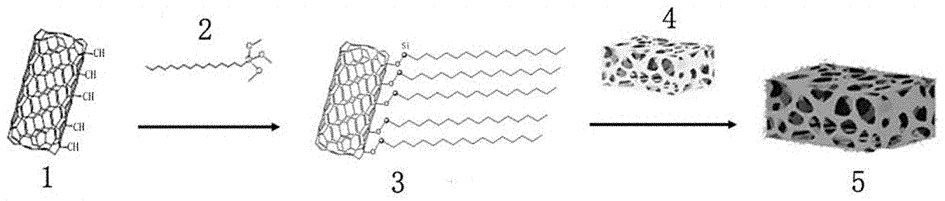

### CROSS-REFERENCE TO RELATED APPLICATION

The present application is a Continuation-in-part Application of PCT Application No. PCT/CN2021/101103 filed on Jun. 19, 2021, which claims the benefit of Chinese Patent Application No. 202110157108.1 filed on Feb. 4, 2021. The contents of the above are hereby incorporated by reference in their entirety.

### FIELD OF THE INVENTION

The present disclosure belongs to the technical field of underwater archaeology and underwater cultural heritage protection, and specifically relates to extraction materials for in-situ consolidation and multi-packaging of underwater fragile cultural relics, and extraction and restoration methods.

### BACKGROUND OF THE INVENTION

For thousands of years, a wealth of historical relics has been remained underwater around the world, including marine and inland waters.

However, when the underwater cultural relics are threatened by factors such as biological erosion, chemical corrosion of pollutants, changes in climate or water flow, or disturbed by factors such as human construction and development, it is necessary to protect, research or display them by placing them in a safe and controllable environment.

### SUMMARY OF THE INVENTION

To achieve the above purpose, the present disclosure provides a new extraction method of multi-packaging of an underwater fragile cultural relic of “underwater in-situ consolidation-composite conformable high-strength protective-double-sided self-adhesive bandage binding”.

The present disclosure provides an extraction material for temporary in-situ consolidation and multi-packaging of an underwater fragile cultural relic which comprises a double-layer wrapping layer comprising a temporary consolidation material layer and a conformable high-strength protective layer of composite material from inside to outside, and wherein the conformable high-strength protective layer of composite material mainly comprises a strong-hydrophobic oleophilic sponge adsorbed with aqueous epoxy resin.

In the present disclosure, the strong-hydrophobic oleophilic sponge is a polyurethane sponge impregnated with a solution of strong-hydrophobic multi-walled carbon nanotube which is obtained by chemically reacting —Si—O—Me in long-chain siloxane with a —OH group in a hydroxylated multi-walled carbon nanotube.

In the present disclosure, the long-chain siloxane (2) is hexadecyltrimethoxysilane.

In the present disclosure, the aqueous epoxy resin is bisphenol-A epoxy resin denoted as Component A and a curing agent of modified phenolic amine denoted as Component B is used together with Component A, wherein the Component A and the Component B are mixed with a ratio (2:1 wt/wt) when used and a curing time can be varied with mixing ratios; the strong-hydrophobic oleophilic sponge (5) is coated with anti-adhesion membrane; and the temporary consolidation material layer comprises a fiber cloth attached to a surface of the underwater fragile cultural relic, a frame and a temporary consolidation material filled between the fiber cloth and the frame.

The fiber cloth is a polypropylene fiber cloth, a polyester fiber cloth or a nylon fiber cloth. The fiber cloth has breaking strength of greater than 5cN/dtex, elongation of less than 30%, porosity of greater than 70% and a fiber diameter between 1 and 6 um.

The temporary consolidation material is a single compound or a mixture in which the single compound predominates and accounts for more than 90 wt % and being capable of bonding to wood, metal, ceramic or sand underwater in a molten state at melting point of 40 and 60° C., wherein the single compound is benzophenone or paeonol or veratraldehyde represented by the following structural formulas respectively:

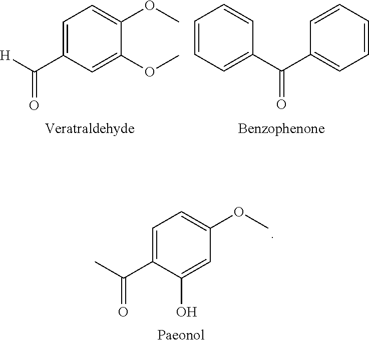

The frame of the present disclosure is a metal mesh frame and made of a metal mesh of a copper or stainless steel with a aperture of 80 to 120 meshes. The metal mesh frame is an enclosure capable of surrounding the cultural relic and having a certain supporting effect, which is designed to fit the morphology of the underwater fragile cultural relic to be extracted and made according to the overlooking plane form of the underwater fragile cultural relic to be extracted, so that the temporary consolidation material is solidified in the enclosure to integrate with contents in the enclosure as a whole.

The extraction material in the present disclosure further comprises a self-adhesive bandage layer as the outermost layer, which is a double-sided self-adhesive nylon braided strap with a width and achieves tight bond by means of physical lock catches.

The present disclosure has the following beneficial effects.

The strong-hydrophobic oleophilic sponge of the conformable high-strength protective layer of composite material can not only prevent water from entering, but also prevent the adsorbed epoxy resin from overflowing. Moreover, the softness of the sponge itself ensures that the conformable high-strength protective layer can package an underwater cultural relic with a complex shape conformably to a hard protective shell after the epoxy resin is cured underwater.

The polyurethane sponge adopted in the modified strong-hydrophobic oleophilic sponge of the present disclosure has: properties required for packaging material conformably, a porous structure into which the large amount of epoxy resin can be adsorbed, a certain thickness itself, flexibility and good ductility, conformability to a morphology of a packaged object, a size that can be tailored according to application needs, and a low cost.

The strong-hydrophobic oleophilic property enables the sponge to fully adsorb the epoxy resin instead of water, thereby avoiding effect of water on the curing rate of the epoxy resin and preventing from carrying inside the sponge during diving due to no air retention inside the sponge.

The strong-hydrophobic oleophilic sponge modified with strong-hydrophobic multi-walled carbon nanotubes in the present disclosure has excellent selective adsorption capacity for oily materials such as uncured resin and is significantly repulsive to water.

The long-chain siloxane in the present disclosure is a hexadecyltrimethoxysilane, which can maximize the hydrophobicity of the multi-walled carbon nanotubes, that is, resulting in contact angles of the multi-walled carbon nanotubes with water of greater than 156°. The long-chain siloxane enable the modified sponge/epoxy resin composite to bond firmly, such that the modified sponge/epoxy resin composite can still maintain its original oil absorptive property and hydrophobic property after being subjected to an adsorption/desorption process ten times and has a contact angle with water changed from 155.9° to 152.2°.

The conformable high-strength protective layer of composite material in the present disclosure further comprises an anti-adhesion membrane. The strong-hydrophobic oleophilic sponge is coated with the anti-adhesion membrane, thereby avoiding bonding of the epoxy resin to other materials when being cured.

### BRIEF DESCRIPTION OF DRAWING

The sole figure is a preparation process flow of a strong-hydrophobic oleophilic polyurethane sponge, wherein 1 represents hydroxylated multi-walled carbon nanotubes, 2 represents long-chain siloxane, 3 represents strong-hydrophobic multi-walled carbon nanotubes, 4 represents a polyurethane sponge, and 5 represents a strong-hydrophobic oleophilic sponge.

### DETAILED DESCRIPTION

The present disclosure discloses an extraction material for temporary in-situ consolidation and multi-packaging of underwater fragile cultural relics. The extraction material includes a three-layer wrapping layer including a temporary consolidation material layer, a conformable high-strength protective layer of composite material and a self-adhesive bandage layer from inside to outside. The self-adhesive bandage layer is a double-sided self-adhesive nylon braided strap having a certain width and can achieve tight bond by means of physical lock catches. The conformable high-strength protective layer of composite material mainly includes a strong-hydrophobic oleophilic sponge 5 adsorbed with aqueous epoxy resin. The strong-hydrophobic oleophilic sponge 5 is a polyurethane sponge 4 impregnated with a solution of strong-hydrophobic multi-walled carbon nanotube 3 which is obtained by chemically reacting —Si—O—Me in long-chain siloxane 2 with a —OH group in a hydroxylated multi-walled carbon nanotube 1. The long-chain siloxane 2 is preferably hexadecyltrimethoxysilane.

The aqueous epoxy resin is bisphenol-A epoxy resin denoted as Component A and a curing agent of modified phenolic amine denoted as Component B is used together with Component A, wherein the Component A and the Component B are mixed with a ratio (2:1 wt/wt) when used and a curing time can be varied with mixing ratios; the strong-hydrophobic oleophilic sponge 5 is coated with anti-adhesion membrane; and the temporary consolidation material layer comprises a fiber cloth attached to a surface of the underwater fragile cultural relic, a frame and a temporary consolidation material filled between the fiber cloth and the frame.

The fiber cloth is a polypropylene fiber cloth, a polyester fiber cloth or a nylon fiber cloth. The fiber cloth has breaking strength of greater than 5 cN/dtex, elongation of less than 30%, porosity of greater than 70% and a fiber diameter between 1 and 6 um.

The temporary consolidation material is a single compound or a mixture in which the single compound predominates and accounts for more than 90 wt % and being capable of bonding to wood, metal, ceramic or sand underwater in a molten state, wherein the single compound is benzophenone or paeonol or veratraldehyde represented by the following structural formulas respectively:

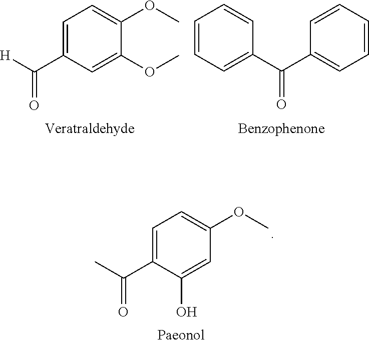

The frame of the present disclosure is a metal mesh frame and made of a metal mesh of a copper or stainless steel with an aperture of 80 to 120 meshes, preferably 90-120 mesh. The metal mesh frame is an enclosure capable of surrounding the cultural relic and having a certain supporting effect, which is designed to fit the morphology of the underwater fragile cultural relic to be extracted and made according to the overlooking plane form of the underwater fragile cultural relic to be extracted, so that the temporary consolidation material is solidified in the enclosure to integrate with contents in the enclosure as a whole.

The present disclosure provides an extraction method using an extraction material for temporary in-situ consolidation and multi-packaging of underwater fragile cultural relics. A strong-hydrophobic oleophilic sponge 5 is prepared before used. Several strong-hydrophobic oleophilic sponges are prepared in order to meet requirement for packaging an underwater cultural relic and convenient disassembly. The strong-hydrophobic oleophilic sponge 5 adsorbed fully with aqueous epoxy resin is coated with an anti-adhesion membrane and sent to underwater for secondary conformable packaging. The present disclosure provides a complete set of methods for underwater in-situ consolidation and multi-packaging extraction and laboratory restoration of underwater fragile cultural relics and heritages, including the following steps.

Step 1: advance preparation on land: obtaining a solution of hydroxylated multi-walled carbon nanotubes 1 by reacting long-chain siloxane 2 and strong-hydrophobic multi-walled carbon nanotube 3 with controlling pH of 9.0 to 10.0; impregnating a polyurethane sponge 4 with the solution of strong-hydrophobic multi-walled carbon nanotube 3 to a strong-hydrophobic oleophilic polyurethane sponge 4, wherein the size of the polyurethane sponge 4 is suitable for underwater wrapping; mixing bisphenol-A epoxy resin as Component A and a curing agent of modified phenolic amine as Component B at a mass ratio and coating the mixture on the strong-hydrophobic oleophilic sponge 5 to prepare a modified sponge/epoxy resin composite. The process of Step 1 is shown in the sole figure.

Step 2: removing sediment on a surface layer without disturbing the underwater fragile cultural relic and heritage.

Step 3: assembling a metal mesh frame with a shape slightly larger than that of the cultural relic to be extracted and a height slightly higher than that of the cultural relic to be extracted.

Step 4: enclosing the cultural relic and heritage using the metal mesh frame after removing sediment and other things on side faces of the cultural relic and heritage.

Step 5: attaching a plurality of fiber cloths to the surfaces of the underwater fragile cultural relic and injecting a molten consolidation material onto the surfaces of the fiber cloths with an injector to integrate the fiber cloths with the fragile cultural relic as a whole.

Step 6: curing the temporary consolidation material underwater to form a temporary solid body in which the cultural relic and heritage is enclosed by the metal mesh frame.

Step 7: transporting the modified sponge/epoxy resin composite prepared in Step 1 which is packed with a tailored plastic valve bag to underwater before the epoxy resin was cured.

Step 8: inserting a polyfluortetraethylene plate under the temporary solid body having the metal mesh frame to slightly lift the frame and repackaging the temporary solid body with two or more of the modified sponge/epoxy resin composite in different directions and fixing joints of the composites with clamps.

Step 9: with as little movement of the re-packaged solid body as possible, reinforcing the re-packaged solid body by third-packaging using double-sided self-adhesive bandages underwater, wherein the re-packaged solid body was wrapped transversely firstly and then longitudinally, and leaving alone until the aqueous epoxy resin was completely cured to became hard overall, forming a hard conformable shell that meets strength required for protection.

Step 10: moving carefully and extracting slowly the packaged solid body from underwater, and transporting to storage location.

Step 11: from the outer layer to the inner layer, peeling off the double-sided self-adhesive bandages, and taking off the cured and relatively hard layers of epoxy resin composite after extracting the cultural relic from underwater.

Step 12: placing the solid body having the metal mesh frame into a container paved with fine sand on the bottom and slowly injecting 10 to 30 wt % of ethanol solution into the container, and removing the metal mesh frame after 12 to 48 h when the consolidation material was gradually dissolved.

Step 13: replacing the soaking solution with clear water, and sweepping sediments on the cultural relic gently to show its original appearance underwater.

Step 14: pumping the clear water out and leaving the cultural relic alone at normal temperature for several days or placing it in a heating and ventilation environment at a temperature ≤50° C. to sublimate the underwater temporary consolidation material automatically to restore its original appearance for exhibition in an air environment.

### Example 1

The Example provides a set of methods for underwater in-situ consolidation and multi-packaging extraction and laboratory restoration of fragile cultural relics and heritages underwater. According to the disclosure and implementation steps of the present disclosure, taking a loose lacquer tray with rotten wooden-body as an example, the lacquer tray was extracted from underwater sand to land under the condition of maintaining its original condition and restored to its original appearance of the loose lacquer tray in air. The implementation steps of methods is as follows.

(1) advance preparation on land: hexadecyltrimethoxysilane was reacted with commercially available hydroxylated multi-walled carbon nanotubes 1 at a pH of 9.0 to 10.0 to obtain a solution of strong-hydrophobic multi-walled carbon nanotube. A commercially available polyurethane sponge 4 with suitable thickness and size for packaging underwater was impregnated with the solution to prepare the strong-hydrophobic oleophilic polyurethane sponge 4. Then bisphenol-A epoxy resin (JH-5553) as Component A and a curing agent of modified phenolic amine as Component B were mixed at a ratio (2:1 wt/wt) and coated on the strong-hydrophobic oleophilic sponge 5 to prepare a modified sponge/epoxy resin composite.

(2) the loose lacquer tray with rotten wooden body which was buried in underwater sediment were cleaned carefully to remove the sediment on its surface layer, starting at its exposed portion from the underwater sediment, until the whole upper surface of the lacquer tray was exposed.

(3) A polypropylene fiber cloth with roughly the same size as the lacquer tray was attached to the surface of the lacquer tray. The fiber cloth can be fixed by small stones to prevent the fiber cloth from being carried away by water. Molten veratraldehyde was injected onto the surface of the fiber cloth with an injector to integrate the fiber cloth into the lacquer tray as a whole.

(4) A frame slightly larger than the lacquer tray in shape and slightly higher than the lacquer tray in height was assembled by 100-mesh 304 stainless steel metal meshes.

(5) After the sediment on side faces of the lacquer tray were removed away, the lacquer tray was enclosed by the metal mesh frame.

(6) The molten veratraldehyde was injected into the metal mesh frame with the injector until the metal mesh frame was fully filled, and cured to integrate the the lacquer tray with the metal mesh frame as a a whole.

(7) The prepared modified sponge/epoxy resin composite which is packed with a tailored plastic valve bag was transported to underwater for repackaging the temporary solid body having the metal mesh frame.

(8) A polyfluortetraethylene plate was inserted under the temporary solid body having the metal mesh frame to slightly lift the frame and the temporary solid body was repackaged with two or more of the modified sponge/epoxy resin composites in different directions. The joints of the composites were fixed with clamps.

(9) With as little movement of the re-packaged solid body as possible, the re-packaged solid body by third-packaging was reinforced using double-sided self-adhesive bandages underwater, wherein the re-packaged solid body was wrapped transversely firstly and then longitudinally, and leaving alone for 2-3 hours until the aqueous epoxy resin was completely cured to became hard overall, forming a hard conformable shell that meets strength required for protection.

(10) The packaged solid body was moved carefully and extracting slowly from underwater, and was transported to storage location.

(11) From the outer layer to the inner layer of the packaged solid body, the double-sided self-adhesive bandages were peeled off and the cured and relatively hard layers of epoxy resin composite were taken off.

(12) The solid body having the metal mesh frame was placed into a container paved with fine sand on the bottom and 20 wt % of ethanol solution was slowly injected into the container. After three days, the metal mesh frame was removed carefully when the veratraldehyde was gradually dissolved.

(13) The soaking solution was replaced with clear water and the lacquer tray was sweeped gently to remove the remained sediments, showing its original appearance underwater.

(14) The clear water was pumped out and the lacquer tray was left alone at normal temperature for several days to sublimate the veratraldehyde automatically to restore its original appearance for exhibition in an air environment.

1. An extraction material for temporary in-situ consolidation and multi-packaging of an underwater fragile cultural relic, wherein the extraction material comprises a double-layer wrapping layer comprising a temporary consolidation material layer and a conformable high-strength protective layer of composite material from inside to outside, wherein
the conformable high-strength protective layer of composite material mainly comprises a strong-hydrophobic oleophilic sponge (5) adsorbed with aqueous epoxy resin, the strong-hydrophobic oleophilic sponge (5) being a polyurethane sponge (4) impregnated with a solution of strong-hydrophobic multi-walled carbon nanotube (3) which is obtained by chemically reacting —Si—O—Me in long-chain siloxane (2) with a —OH group in a hydroxylated multi-walled carbon nanotube (1); and
the temporary consolidation material layer comprises a fiber cloth attached to a surface of the underwater fragile cultural relic, a frame, and a temporary consolidation material filled between the fiber cloth and the frame, the temporary consolidation material being a single compound or a mixture in which the single compound predominates and accounts for more than 90 wt %, and being capable of bonding to wood, metal, ceramic or sand underwater in a molten state, wherein the single compound is benzophenone or paeonol or veratraldehyde represented by the following structural formulas respectively:

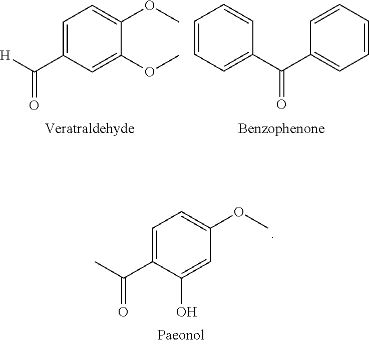

2. The extraction material for temporary in-situ consolidation and multi-packaging of the underwater fragile cultural relic according to claim 1, wherein the long-chain siloxane (2) is hexadecyltrimethoxysilane.

3. The extraction material for temporary in-situ consolidation and multi-packaging of the underwater fragile cultural relic according to claim 1, wherein the aqueous epoxy resin is bisphenol-A epoxy resin denoted as Component A, and a curing agent of modified phenolic amine denoted as Component B is used together with Component A, wherein Component A and Component B are mixed with a ratio (2:1 wt/wt) when used;
the strong-hydrophobic oleophilic sponge (5) is coated with anti-adhesion membrane; and
the fiber cloth is a polypropylene fiber cloth, a polyester fiber cloth or a nylon fiber cloth.

4. The extraction material for temporary in-situ consolidation and multi-packaging of the underwater fragile cultural relic according to claim 2, wherein the aqueous epoxy resin is bisphenol-A epoxy resin denoted as Component A, and a curing agent of modified phenolic amine denoted as Component B is used together with Component A, wherein Component A and Component B are mixed with a ratio (2:1 wt/wt) when used;
the strong-hydrophobic oleophilic sponge (5) is coated with anti-adhesion membrane; and
the fiber cloth is a polypropylene fiber cloth, a polyester fiber cloth or a nylon fiber cloth.
